(19) United States
(12) Patent Application Publication
(10) Pub. No.: US 2006/0036550 A1
(43) Pub. Date: Feb. 16, 2006

(54) Internet based media disc mastering and distribution system

(76) Inventor: Francois Okeh, Ottawa (CA)

Correspondence Address: FRANCOIS OKEH, APT 207, 35 WOODRIDGE CRESCENT, OTTAWA, ON, K2B 7T5, CA

(21) Appl. No.: 11/124,959

(22) Filed: May 10, 2005

(30) Foreign Application Priority Data
Jul. 28, 2004 (CA) 2, 477, 753

(51) Int. Cl. G06Q 99/00

(52) U.S. Cl. 705/51

(57) ABSTRACT

The invention provides a new concept for creating and distributing physical media discs and media disc images including disc cover graphics in the form of computer files. The concept covers the creation and distribution of media discs including but not limited to audio and video CD-ROMs, (S)Video CDs and DVD discs using an Internet application Interface for a plurality of client computers and physical recipients converging to a central Internet server system. The invention encourages a paradigm shift from localized media disc creation and traditional land based shipping and distribution methods for media discs by including a substantial part of the mastering and distribution process in virtual web space using the Internet as a mastering and distribution medium. A working prototype of this invention has been developed and is operational.

### BACKGROUND OF THE INVENTION

The invention pertains to the creation and distribution of media discs for entertainment, informational or commercial purposes. It provides a means for individuals and professionals to create and distribute media discs using a web interface over the Internet. Traditional media disc distribution methods have required multimedia authors to invest in expensive hardware and software to locally create, master and ship their creations to their friends, family or clients. The Internet has thus far only been used as a purchase point with sometimes long and unnecessary shipping times and distances.

The invention uses the Internet as a media disc mastering and distribution point as well, and poses numerous benefits and advantages over current media disc mastering and distribution methods. With a capable worldwide network of web servers and media disc writer drive bays, multimedia authors using this invention are no longer restrained or limited by current physical shipping methods or state border restrictions. Media discs can be delivered by the digital download of a disc image in software or by conventional mail, based on what means are available to the recipient.

A practical example of the flexibility possessed by the invention resides in its ability to accept multimedia files created with most available media editing applications for upload and subsequent media disc creation and distribution. The onus is on the multimedia author to format and compress the multimedia files she wishes to use to create the target media disc type before upload. The inventor has developed a portable software application for this purpose. This software application is portable in the sense that it has been developed with cross computer Operating System design methods and tools.

In addition to the foregoing attributes, a second software application has also been developed to solve the problem of playability with the added benefit of disc trace ability. This is a small media player application that resides and executes from the created media disc. It is added by the invention to every disc created in order to provide uniform playback of the media disc content. Optional disc tracing directives for tracing over the Internet may be added at disc creation time using the network Internet application interface. These directives are recorded in a configuration file that also resides on the distributed media disc. Disc tracing directives are read and executed when the player application runs.

It can thus be seen that the present invention provides a novel approach to media disc creation and distribution. It successfully integrates the need for multimedia authors to distribute or sell their creations to a worldwide audience using the convenience and power of the Internet.

### BREIF SUMMARY OF THE INVENTION

The invention pertains to a system of networked Internet servers, which provide a central media disc creation and distribution solution across the world. With this invention, multimedia authors are able to upload media content from client computers to individual accounts on the network, specify a media disc type, create, send and optionally trace a media disc using a simple web interface and underlying web application.

Two delivery methods are available to media authors through the network web interface. Authors may send a download link to a successfully created disc image from their account to a third party or they may specify a physical disc type (Audio, (S)Video CD, DVD) for delivery over conventional mail to the recipient of their choice.

Media files must be specifically formatted before they can be uploaded to the network through the network web interface. A software application has been developed by the inventor to address this issue although the use of this application is not mandatory.

Recipients of disc images and physical discs must be equipped with the proper software to play back the content of the discs they receive. For this purpose, the inventor has developed a software application that resides on the media disc to provide considerable universal access to the media disc content. This application also has the added benefit of providing disc-tracking options to multimedia authors by the use of disc configuration file directives sent back through the Internet to the central web server.

### BREIF DESCRIPTION OF THE SEVERAL VIEWS OF THE DRAWINGS

In the drawings which form part of this specification:

FIG. 1 is a diagrammatic view of two users transferring media files through the custom web application over the Internet to their respective accounts on the central web server.

FIG. 2 shows the flow of operation as the first user 2 instructs the server through the custom web application to send a download link to her creation through an email message to a third party recipient. No manual intervention from sender to receiver is required in this case. The sender only has to specify the recipient email address.

FIG. 3 describes the alternate flow of operation as the second user 3 instructs the central web server through the custom web application to use her uploaded file content to create and send a physical media disc to a physical land based address. In this case, some manual intervention is required to create, collect and ship the media disc. Strategically placed drive bays networked over the Internet can be used to reduce shipping costs, times or restrictions between countries.

### DETAILED DESCRIPTION OF THE INVENTION

The particularly advantageous nature of the invention is in its distributed design. Multimedia authors and recipients of media discs can be located anywhere in the world. The delivery of media content, although enhanced by the availability of a fast Internet connection, does not require such a connection to exist at the recipient end to function. Discs can be delivered by conventional mail methods.

In the illustrations relating to the following description, solid black arrows indicate flow of execution for connections through which data is being transferred. Dashed lines show the path of data through the Internet while double lines with no arrowheads depict connections that are not receiving any data. Connection to the server drive bay 6 may be remote, through the Internet or direct by interface cable (e.g. SCSI, IDE, USB or IEEE 1394). The invention works as follows:

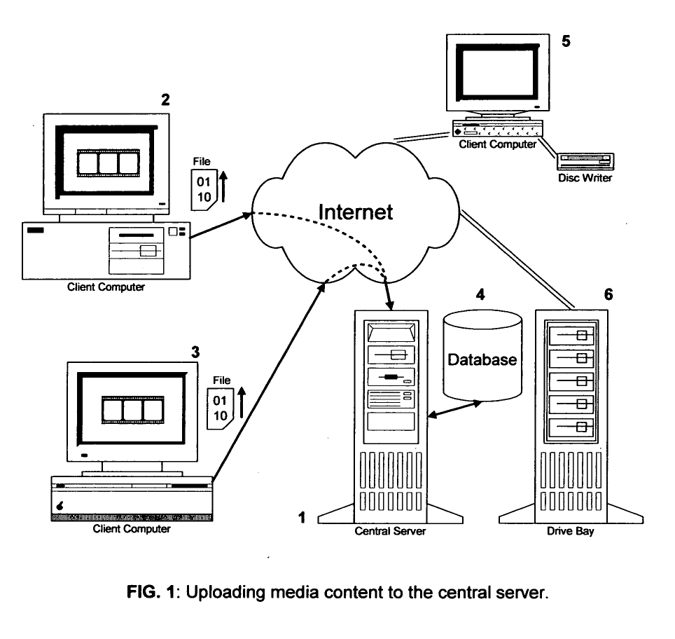

As shown in FIG. 1, a central server system 1 runs a custom web application, which enables subscribed multimedia authors 2 and 3 to upload multimedia files that they have created on their computer into their individual account space on the network. Disc cover graphics may also be uploaded at this stage. User changes and settings are recorded to a database 4.

The multimedia authors 2 and 3 through the web application may convert their media files into a media disc image. The created disc image and cover graphics are bundled into a single downloadable file archive using logic programmed into the central server system. A software program to play back the disc once it is created from its related image is self-contained on the disc. Media disc recipients will rarely need to install additional software to play back the contents of the discs they receive, unless specified by the media author. This software program, which is sef-contained on every created disc, is an interface to software decoding entities already present or installable on most operating systems. These software-decoding entities are called CODECs (short for “COmpressor/DECompressor”).

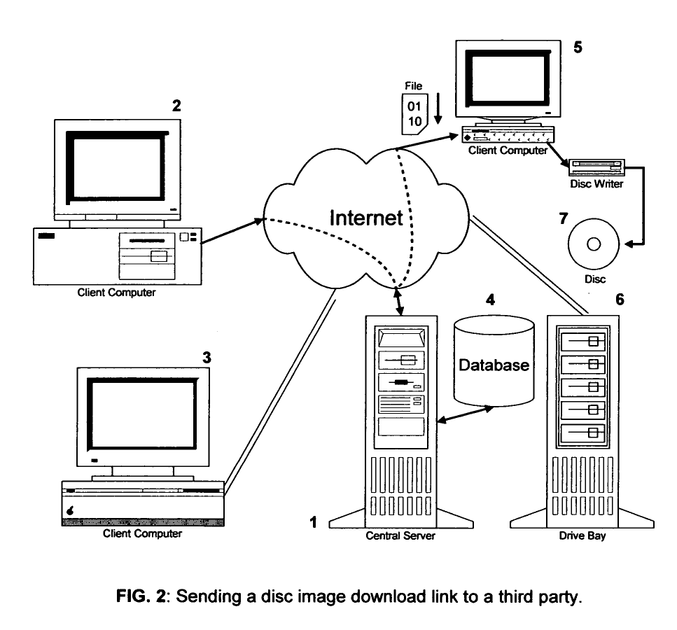

In the first sequence shown in FIG. 2, the first multimedia author 2 chooses to forward a download link to her creation for a third party recipient 5 to download through an email message. The author 2 is able to initiate such action through the network web interface and application. The recipient 5 upon receiving this email message can then proceed to click on a web link, embedded into the email message to download the target disc image and cover graphics which are at this point combined into a single file archive. To reproduce the disc 7 in question, the recipient uses the media disc image and disc cover graphics contained in the downloaded file archive.

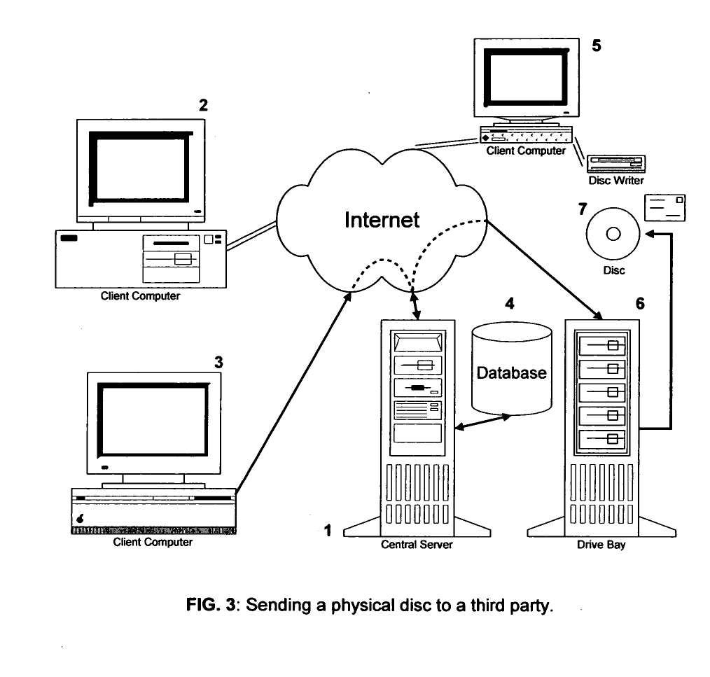

In the alternative sequence shown in FIG. 3, the second multimedia author 3 chooses to have a physical disc mailed to a recipient by conventional mail methods in a specific media disc format. The author 3 is able to initiate such action through the network web interface and application. This results in the disc specification, content and mailing instructions specified by the multimedia author 3 to be placed in queue to a connected disc writer drive bay 6 for further fulfillment. The disc 7 is collected and shipped by conventional mail.

The embodiments of the invention in which an exclusive property or privilege is claimed are defined as follows:

1. A method for authoring and distributing media discs through a web interface, comprising of author initiated download links sent to recipients via email with an alternative conventional mail delivery option.

2. The combination defined in claim 1, wherein a method is included to ensure recipient playback compatibility by making a player interface application self-contained on the media disc.

3. The combination defined in claim 1, with a distributed network delivery system to ensure the shortest delivery time and cost to media disc authors and recipients.

4. The combinations defined in claims 1 and 3, wherein data discs are distributed instead of media discs.

5. A method for incorporating pre-determined statistical information in the form of a configuration file on a media or data disc for transmission over the Internet, comprising of a self contained software application on the disc, which transmits the configuration file data to a central server system in order to provide statistical information to the media or data disc author.
